(19) United States
(12) Patent Application Publication
(10) Pub. No.: US 2022/0165263 A1
(43) Pub. Date: May 26, 2022

(54) ELECTRONIC APPARATUS AND METHOD OF CONTROLLING THE SAME

(71) Applicant: Samsung Electronics Co., Ltd., Suwon-si (KR)

(72) Inventors: Chanhee CHOI, Suwon-si (KR); Hana KIM, Suwon-si (KR)

(21) Appl. No.: 17/450,778

(22) Filed: Oct. 13, 2021

Related U.S. Application Data
(63) Continuation of application No. PCT/KR2021/012885, filed on Sep. 17, 2021.

(30) Foreign Application Priority Data
Nov. 25, 2020 (KR) 10-2020-0160434

(51) Int. Cl. G10L 15/22

(52) U.S. Cl. CPC G10L 15/22; G10L 2015/223

(57) ABSTRACT

Disclosed is provided an electronic apparatus comprising: a processor configured to: identify a first section of a received audio signal corresponding to a trigger word based on the received audio signal, identify whether a third section corresponding to a speech input is present in the audio signal received after the identified first section based on a noise characteristic identified from a second section of the audio signal received before the first section, and cause an operation corresponding to the user command word to be performed based on the identified third section of the audio signal.

### CROSS-REFERENCE TO RELATED APPLICATIONS

This application is a national stage of International Application No. PCT/KR2021/012885 designating the United States, filed on Sep. 17, 2021, in the Korean Intellectual Property Receiving Office and claiming priority to Korean Patent Application No. 10-2020-0160434, filed on Nov. 25, 2020, in the Korean Intellectual Property Office, the disclosures of which are incorporated by reference herein in their entireties.

### BACKGROUND

### Field

The disclosure relates to an electronic apparatus having improved speech-recognition efficiency and a control method thereof.

### Description of Related Art

With popularization of speech recognition technology and generalization of a speech recognition function provided by an electronic apparatus, there has been improved technology of detecting a trigger word (or a wakeup word) uttered by a user to execute the speech recognition, or recognizing a user speech input corresponding to a function to be implemented.

A voice section in a received audio signal may be detected based on voice activity detection (VAD) or end point detection (EPD), and begin of speech (BoS) and end of speech (EoS) are identified by analyzing waveforms of a noise section and a speaking section.

The VAD refers to technology applied to voice processing for detecting presence of voice. In terms of using the VAD, the electronic apparatus activates the VAD always or after recognition of the trigger word because a user may speak at any time. In the case where the VAD is always activated, resource consumption increases due to wasteful operations, and a malfunction irrelevant to a user's intention is highly likely to occur because it is ambiguous to establish a criterion for distinguishing between speech and noise. In the case where the VAD is activated after the recognition of the trigger word, when the trigger command and the user speech input are uttered one after another, it is difficult to establish a criterion for identifying noise and thus it is highly likely to fail in detecting an end point of speech.

To detect the end point of the speech in the EPD, a start point of the speech is required to be detected before detecting the end point of the speech. Therefore, like the VAD, the EPD also has a problem that it is difficult to establish a criterion for identifying noise when the trigger command and the user speech input are uttered one after another.

General methods of detecting a voice section include a method of detecting the section based on energy calculatable by analyzing an audio signal in units of frames, a method of using a zero-crossing rate, a method of distinguishing between voice and nonvoice by applying machine learning to extracted characteristics, etc.

The method of detecting the voice section based on the audio-signal energy in units of frames or based on the zero-crossing rate often identifies speech and noise because of the ambiguous criterion. To make up for such misidentification, there has been proposed a method of comparing a characteristic with that of a previous frame in units of frames and distinguishing between speech and noise when a difference in a characteristic is greater than or equal to a threshold value designated by a system, but unexpected noisy environments which are not defined by the system may largely degrade the performance of this method. The method of analyzing characteristics based on the machine learning is more accurate than the method of analyzing a signal in units of frames based on the energy or zero-crossing rate, but has shortcomings of consuming relatively high resources to obtain results.

Further, it is unclear in a conventional remote speech-recognition system until when a user can speak after the triggering. For example, in a quiet environment, relatively simple VAD is sufficient to detect an end point of a user's speech, but it is still difficult to identify a user's intention of additionally speaking after the end point detected by the system. Further, in a noisy environment, speech recognition is terminated at a given timeout of the system because it is difficult to accurately identify a noise section and it is therefore hard to exactly detect an end point of speech. Accordingly, the system may stop a user from speaking regardless of the user's intention, and the use cannot get feedback on why a speaking input is stopped.

### SUMMARY

Embodiments of the disclosure provide an electronic apparatus having improved speech-recognition efficiency and a control method thereof.

According to an example embodiment of the disclosure, an electronic apparatus is provided, the electronic apparatus comprising: a processor configured to: identify a first section of a received audio signal corresponding to a trigger word based on the received audio signal, identify whether a third section corresponding to a user command word is present in the audio signal received after the identified first section based on a noise characteristic identified from a second section of the audio signal received before the first section, and causing an operation corresponding to the user command word to be performed based on the audio signal of the identified third section.

According to an example embodiment, the electronic apparatus may further include a storage, wherein the processor is configured to: control the electronic apparatus to store data related to lengths of time corresponding to the first section and the second section of the received audio signal in the storage; and identify the first section and the second section based on the stored data.

The processor is configured to: identify a length of time corresponding to the first section based on a standard length of the first section based on a reference audio signal.

The processor is configured to: identify presence of the third section or the noise characteristic in units of frames based on the received audio signal.

The processor is configured to: identify the second section comprising a margin time preceding a start point of the first section.

The processor is configured to: identify an end point of the first section based on the identified noise characteristic, and identify whether the third section is present in the audio signal received after the identified end point.

The processor is configured to: identify a standard length of the first section based on a reference audio signal, and identify the end point of the first section based on the identified standard length.

The processor is configured to: identify a speech characteristic based on the first section, and to control an electronic device to perform an operation corresponding to a user command word of the third section based on the identified speech characteristic.

According to an example embodiment, the electronic apparatus may further include: a display, wherein the processor is configured to control the display to display a graphic user interface (GUI) corresponding to a changed state of the audio signal received after the first section.

The processor is configured to: identify whether the audio signal is user speech or noise based on the changed state of the audio signal, and control the display to display the GUI varied depending on the identified user speech or noise.

The processor is configured to: control the display to display the GUI varied as time goes on after the end point of the first section.

According to an example embodiment of the disclosure, a method of controlling an electronic apparatus is provided, the method comprising: identifying a first section of a received audio signal corresponding to a trigger word based on the received audio signal; identifying whether a third section corresponding to a user command word is present in the audio signal received after the identified first section based on a noise characteristic identified from a second section of the audio signal received before the first section; and causing an operation corresponding to the user command word to be performed based on the audio signal of the identified third section.

According to an example embodiment, the method may further comprise: storing data related to lengths of time corresponding to the first section and the second section of the received audio signal; and identifying the first section and the second section based on the stored data.

The identifying the first section comprises: identifying a length of time corresponding to the first section based on a standard length of the first section based on a reference audio signal.

The identifying the second section comprises: identifying the second section comprising a margin time preceding a start point of the first section.

According to an example embodiment, the method may further comprise: identifying an end point of the first section based on the identified noise characteristic; and identifying whether the third section is present in the audio signal received after the identified end point.

The identifying the end point of the first section comprises: identifying a standard length of the first section based on a reference audio signal; and identifying the end point of the first section based on the identified standard length.

According to an example embodiment, the method may further comprise: displaying a graphic user interface (GUI) corresponding to a changed state of the audio signal received after the first section.

The displaying the GUI comprises: identifying whether the audio signal is user speech or noise based on the changed state of the audio signal; and displaying the GUI varied depending on the identified user speech or noise.

According to an example embodiment of the disclosure, a non-transitory computer-readable recording medium is provided, in which a computer program is stored comprising a code which, when executed by a processor, cause an electronic apparatus to perform operations comprising: identifying a first section of a received audio signal corresponding to a trigger word based on the received audio signal; identifying whether a third section corresponding to a user command word is present in the audio signal received after the identified first section based on a noise characteristic identified from a second section of the audio signal received before the first section; and controlling an electronic device to perform an operation corresponding to the user command word based on the audio signal of the identified third section.

According to an example embodiment of the disclosure, a present noise characteristic and a present speech characteristic based on a triggered point of a trigger word are used to thereby efficiently and accurately analyze a user speech input while consuming the minimum and/or reduced system resources with regard to a speaking section and a noise section.

According to an example embodiment of the disclosure, it is possible to clearly identify the speaking section and the noise section even in an environment with included noise, thereby guiding a user to normally input speech while checking his/her own speech input state. Further, operations are performed after the recognition of the trigger word, thereby having advantages of consuming the minimum and/or reduced system resources and exhibiting performance even under the noisy environment without depending on a specific threshold value.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating example operations of an electronic apparatus according to various embodiments;

FIG. 2 is a block diagram illustrating an example configuration of an electronic apparatus according to various embodiments;

FIG. 3 is a flowchart illustrating example operations of an electronic apparatus according to various embodiments;

FIG. 4 is a diagram illustrating an example audio signal received in an electronic apparatus according to various embodiments;

FIG. 5 is a diagram illustrating an example audio signal received in an electronic apparatus according to various embodiments;

FIG. 6 is a diagram illustrating an example audio signal received in an electronic apparatus according to various embodiments;

FIG. 7 is a diagram illustrating an example audio signal received in an electronic apparatus according to various embodiments; and

FIG. 8 is a diagram illustrating an example audio signal received in an electronic apparatus according to various embodiments.

### DETAILED DESCRIPTION

Below, example embodiments of the disclosure will be described in greater detail with reference to the accompanying drawings. In the drawings, like numerals or symbols refer to like elements having substantially the same or similar function, and the size of each element may be exaggerated for clarity and convenience of description. However, the disclosure and its key components and functions are not limited to those described in the following example embodiments. In the following descriptions, details about publicly known technologies or components may be omitted if they unnecessarily obscure the gist of the disclosure.

In the following example embodiments, terms ‘first’, ‘second’, etc. are simply used to distinguish one element from another, and singular forms are intended to include plural forms unless otherwise mentioned contextually. In the following example embodiments, it will be understood that terms ‘comprise’, ‘include’, ‘have’, etc. do not preclude the presence or addition of one or more other features, numbers, steps, operation, elements, components or combination thereof. In addition, a ‘module’ or a ‘portion’ may perform at least one function or operation, be achieved by hardware, software or combination of hardware and software, and be integrated into at least one module. In the disclosure, at least one among a plurality of elements refers to not only all the plurality of elements but also both each one of the plurality of elements excluding the other elements and a combination thereof.

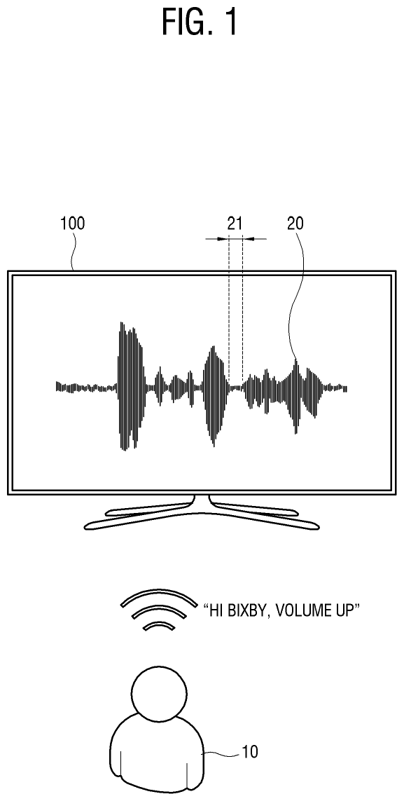

FIG. 1 is a diagram illustrating example operations of an electronic apparatus according to various embodiments.

FIG. 1 illustrates an electronic apparatus 100, a user 10, and an audio signal 20 corresponding to speech received from the user 10, e.g., “Hi Bixby, volume up”. The audio signal 20 is displayed for convenience of describing an audio signal corresponding to received user speech according to the disclosure, and is used while the electronic apparatus 100 is operating. The audio signal is not necessarily displayed in the electronic apparatus 100 as shown in FIG. 1. However, for user convenience, the audio signal may be intuitively displayed in the electronic apparatus 100 to inform a user that speech is being received.

The electronic apparatus 100 according to an embodiment of the disclosure may be embodied by a display apparatus capable of displaying an image, or may be embodied by an apparatus including no display.

For example, the electronic apparatus 100 shown in FIG. 1 is embodied by a television (TV), but may also be embodied by, for example, and without limitation, an artificial intelligence (AI) assistance device (an AI loudspeaker, etc.), a computer, a smartphone, a tablet personal computer (PC), a laptop computer, various displays such as a head mounted display (HMD), a near eye display (NED), a large format display (LFD), a digital signage, a digital information display (DID), a video wall, a projector display, a quantum dot (QD) display panel, quantum dot light-emitting diodes (QLED), micro light-emitting diodes (μLED), a mini LED, etc., a camera, a camcorder, a wearable device, an electronic photo frame, an electronic frame, and so on.

Further, the electronic apparatus 100 may be embodied by various kinds of apparatuses such as a set-top box with no display, and the like image processing apparatus, a refrigerator, a Bluetooth loudspeaker, a washing machine, and the like home appliances, a computer and the like information processing apparatus, and so on.

When the user 10 wants to use the speech-recognition function of the electronic apparatus 100, the user 10 speaks a trigger word, e.g., “Hi Bixby” previously defined to trigger the speech-recognition function of the electronic apparatus 100 and then speaks a user speech input about a function desired to be used, e.g., a command such as “volume up”. The user speech input may include a user command word according to an embodiment of the disclosure. The trigger word may be input through, but not limited to, a user input 130 (to be described in greater detail below) of the electronic apparatus 100, a remote controller separated from the electronic apparatus 100, etc. as well as a user's speech.

When the electronic apparatus 100 receives the trigger word, the electronic apparatus 100 gets ready to identify the user speech input received subsequent to the trigger word. The readiness to identify the user speech input may include operations of analyzing a received audio signal and extracting a signal of the user speech input spoken by a user. In this case, the electronic apparatus 100 does not always receive only a user's valid speech, and thus needs to identify which signal corresponds to noise or speech in order to remove an audio signal corresponding to the noise from the received audio signal. As an example of identifying the audio signal corresponding to the noise, the electronic apparatus 100 may regard and analyze an audio signal, which is obtained between the trigger word and the user speech input, e.g., after the speech-recognition function of the electronic apparatus 100 is triggered by the trigger word and before the user speech input is received, as an audio signal corresponding to noise.

However, an interval between the trigger word and the user speech input may be short because of a user's speaking style. In other words, a user speech input may be spoken immediately after the trigger word is spoken and before the electronic apparatus 100 gets ready to identify a subsequent user speech input. For example, as shown in FIG. 1, when the audio signal 20 is obtained based on speech of “Hi Bixby, volume up”, an interval 21 between the trigger word and the user speech input is too short to fully obtain information about a signal corresponding to noise. Further, as described above, the user speech input may be spoken at the same time when not a user's speech but a button input or the like user input for triggering the speech-recognition function may be made. In this case, the electronic apparatus 100 does not have enough information to distinguish between speech and noise, and it is difficult to extract the end point of the trigger word or the start point of the user speech input, thereby lowering the efficiency and reliability of the speech recognition.

Below, the disclosure discloses measures to address such problems.

The disclosure is applicable to not only the case where the interval between the trigger word and the user speech input is short but also the case where it is difficult to obtain information about noise from an audio signal corresponding to the section according to conditions. However, for convenience of description, description will be made below based on the case where the interval between the trigger word and the user speech input is short.

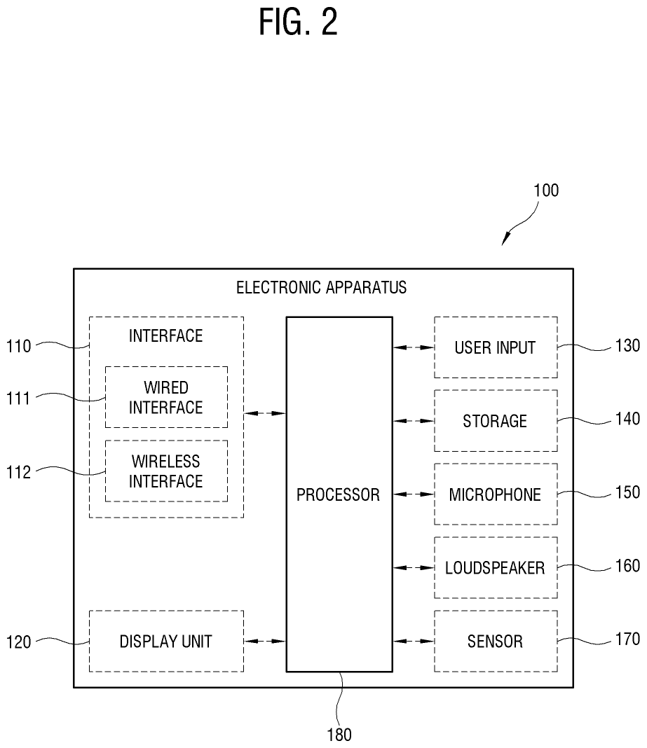

FIG. 2 is a block diagram illustrating an example configuration of an electronic apparatus according to various embodiments.

As shown in FIG. 2, the electronic apparatus 100 may include an interface (e.g., including interface circuitry) 110.

The interface 110 may include various interface circuitry, including, for example, a wired interface 111. The wired interface 111 may include a connector or port to which an antenna for receiving a broadcast signal based on a terrestrial/satellite broadcast or the like broadcast standards is connectable, or a cable for receiving a broadcast signal based on cable broadcast standards is connectable. The electronic apparatus 100 may include a built-in antenna for receiving a broadcast signal. The wired interface 111 may include a connector, a port, etc. based on video and/or audio transmission standards, such as, for example, and without limitation, an HDMI port, DisplayPort, a DVI port, a thunderbolt, composite video, component video, super video, syndicat des constructeurs des appareils radiorécepteurs et téléviseurs (SCART), etc. The wired interface 111 may include a connector, a port, etc. based on universal data transmission standards like a universal serial bus (USB) port, etc. The wired interface 111 may include a connector, a port, etc. to which an optical cable based on optical transmission standards is connectable. The wired interface 111 may include a connector, a port, etc. to which an external microphone or an external audio device including a microphone is connected, and which receives or inputs an audio signal from the audio device. The wired interface 111 may include a connector, a port, etc. to which a headset, an ear phone, an external loudspeaker or the like audio device is connected, and which transmits or outputs an audio signal to the audio device. The wired interface 111 may include a connector or a port based on Ethernet or the like network transmission standards. For example, the wired interface 111 may be embodied by a local area network (LAN) card or the like connected to a router or a gateway by a wire.

The wired interface 111 may be connected to a set-top box, an optical media player or the like external apparatus or an external display apparatus, a loudspeaker, a server, etc. by a cable in a manner of one to one or one to N (where, N is a natural number) through the connector or the port, thereby receiving a video/audio signal from the corresponding external apparatus or transmitting a video/audio signal to the corresponding external apparatus. The wired interface 111 may include connectors or ports to individually transmit video/audio signals.

Further, according to an embodiment, the wired interface 111 may be embodied as built in the electronic apparatus 100, or may be embodied in the form of a dongle or a module and detachably connected to the connector of the electronic apparatus 100.

The interface 110 may include a wireless interface 112. The wireless interface 112 may be embodied variously corresponding to the types of the electronic apparatus 100. For example, the wireless interface 112 may use wireless communication based on radio frequency (RF), Zigbee, Bluetooth, Wi-Fi, ultra-wideband (UWB), near field communication (NFC), etc. The wireless interface 112 may be embodied by a wireless communication module that performs wireless communication with an access point (AP) based on Wi-Fi, a wireless communication module that performs one-to-one direct wireless communication such as Bluetooth, etc. The wireless interface 112 may wirelessly communicate with a server on a network to thereby transmit and receive a data packet to and from the server. The wireless interface 112 may include an infrared (IR) transmitter and/or an IR receiver to transmit and/or receive an IR signal based on IR communication standards. The wireless interface 112 may receive or input a remote control signal from a remote controller or other external devices, or transmit or output the remote control signal to other external devices through the IR transmitter and/or IR receiver. The electronic apparatus 100 may transmit and receive the remote control signal to and from the remote controller or other external devices through the wireless interface 112 based on Wi-Fi, Bluetooth or the like other standards.

The electronic apparatus 100 may further include a tuner to be tuned to a channel of a received broadcast signal, when a video/audio signal received through the interface 110 is a broadcast signal.

When the electronic apparatus 100 includes a display apparatus, the electronic apparatus 100 may include a display unit (e.g., including a display) 120. The display unit 120 includes a display for displaying an image on a screen. The display has a light-receiving structure such as, for example, and without limitation, a liquid crystal type or a light-emitting structure like an OLED type. The display unit 120 may include an additional component according to the types of the display. For example, when the display is of the liquid crystal type, the display unit 120 includes a liquid crystal display (LCD) panel, a backlight unit for emitting light, a panel driving substrate for driving the liquid crystal of the LCD panel.

The electronic apparatus 100 may include a user input (e.g., including various input circuitry) 130. The user input 130 may include various kinds of input interface circuits for receiving a user's input. The user input 130 may be variously embodied according to the kinds of electronic apparatus 100, and may, for example, include mechanical or electronic buttons of the electronic apparatus 100, a remote controller separated from the electronic apparatus 100, an input unit of an external device connected to the electronic apparatus 100, a touch pad, a touch screen installed in the display unit 120, etc.

The electronic apparatus 100 may include a storage (e.g., memory) 140. The storage 140 is configured to store digitalized data. The storage 140 includes a nonvolatile storage which retains data regardless of whether power is on or off, and a volatile memory to which data to be processed by the processor 180 is loaded and which retains data only when power is on. The storage includes a flash-memory, a hard-disc drive (HDD), a solid-state drive (SSD) a read only memory (ROM), etc. and the memory includes a buffer, a random access memory (RAM), etc.

The storage 140 may be configured to store information about an AI model including a plurality of layers. To store the information about the AI model may refer to storing various pieces of information related to operations of the AI model, for example, information about the plurality of layers included in the AI model, information about parameters (e.g. a filter coefficient, a bias, etc.) used in the plurality of layers, etc. For example, the storage 140 may be configured to store information about an AI model learned to obtain upscaling information of an input image (or information related to speech recognition, information about objects in an image, etc.) according to an embodiment. However, when the processor is embodied by hardware dedicated for the AI model, the information about the AI model may be stored in a built-in memory of the processor.

The electronic apparatus 100 may include a microphone 150. The microphone 150 collects a sound of an external environment such as a user's speech. The microphone 150 transmits a signal of the collected sound to the processor 180. The electronic apparatus 100 may include the microphone 150 to collect a user's speech, or receive a speech signal from an external apparatus such as a smartphone, a remote controller with a microphone, etc. through the interface 110. The external apparatus may be installed with a remote control application to control the electronic apparatus 100 or implement a function of speech recognition, etc. The external apparatus with such an installed application can receive a user's speech, and perform data transmission/reception and control through Wi-Fi/BT or infrared communication with the electronic apparatus 100, and thus a plurality of interfaces 110 for the communication may be present in the electronic apparatus 100.

The electronic apparatus 100 may include a loudspeaker 160. The loudspeaker 160 outputs a sound based on audio data processed by the processor 180. The loudspeaker 160 includes a unit loudspeaker provided corresponding to audio data of a certain audio channel, and may include a plurality of unit loudspeakers respectively corresponding to audio data of a plurality of audio channels. The loudspeaker 160 may be provided separately from the electronic apparatus 100, and in this case the electronic apparatus 100 may transmit audio data to the loudspeaker 160 through the interface 110.

The electronic apparatus 100 may include a sensor 170. The sensor 170 may detect the state of the electronic apparatus 100 or the surrounding states of the electronic apparatus 100, and transmit the detected information to the processor 180. The sensor 170 may include, but not limited to, at least one of a magnetic sensor, an acceleration sensor, a temperature/moisture sensor, an infrared sensor, a gyroscope sensor a positioning sensor (e.g. a global positioning system (GPS)), a barometer, a proximity sensor, and a red/green/blue (RGB) sensor (e.g. an illuminance sensor). It will be possible for those skilled in the art to intuitively deduce the functions of the sensors from their names, and thus detailed descriptions thereof will be omitted. The processor 180 may store a detected value defined by a tap between the electronic apparatus 100 and the external apparatus 200 in the storage 140. In the future, when a user event is detected, the processor 180 may identify whether the user event occurs or not based on whether the detected value matches the stored value.

The electronic apparatus 100 may include the processor 180. The processor 180 may include various processing circuitry including, for example, one or more hardware processors embodied by a CPU, a chipset, a buffer, a circuit, etc. mounted onto a printed circuit board, and may also be designed as a system on chip (SOC). The processor 180 includes modules corresponding to various processes, such as a demultiplexer, a decoder, a scaler, an audio digital signal processor (DSP), an amplifier, etc. when the electronic apparatus 100 is embodied by a display apparatus. Some or all of the modules may be embodied as the SOC. For example, the demultiplexer, the decoder, the scaler, and the like modules related to video processing may be embodied as a video processing SOC, and the audio DSP may be embodied as a chipset separated from the SOC.

The processor 180 may perform control to process input data, based on the AI model or operation rules previously defined in the storage 140. Further, when the processor 180 is an exclusive processor (or a processor dedicated for the AI), the processor 180 may be designed to have a hardware structure specialized for processing a specific AI model. For example, the hardware specialized for processing the specific AI model may be designed as an application specific integrated circuit (ASIC), a field-programmable gate array (FPGA), or the like hardware chip.

The output data may be varied depending on the kinds of AI models. For example, the output data may include, but not limited to, an image improved in resolution, information about an object contained in the image, a text corresponding to a speech, etc.

When a speech signal of a user's speech is obtained through the microphone 150 or the like, the processor 180 may convert the speech signal into speech data. In this case, the speech data may be text data obtained through speech-to-text (STT) processing of converting a speech signal into the text data. The processor 180 identifies a command indicated by the speech data, and performs an operation based on the identified command. Both the process of the speech data and the process of identifying and carrying out the command may be performed in the electronic apparatus 100. However, in this case, system load needed for the electronic apparatus 100 and required storage capacity are relatively increased, and therefore at least a part of the process may be performed by at least one server connected for communication with the electronic apparatus 100 through a network.

The processor 180 according to the disclosure may call and execute at least one instruction among instructions for software stored in a storage medium readable by the electronic apparatus 100 or the like machine. This enables the electronic apparatus 100 and the like machine to perform at least one function based on the at least one called instruction. The one or more instructions may include a code created by a compiler or a code executable by an interpreter. The machine-readable storage medium may be provided in the form of a non-transitory storage medium. The ‘non-transitory’ storage medium is tangible and may not include a signal (for example, an electromagnetic wave), and this term does not distinguish between cases where data is semi-permanently and temporarily stored in the storage medium.

The processor 180 may use at least one of, for example, and without limitation, machine learning, a neural network, or a deep learning algorithm as a rule-based or AI algorithm to perform at least part of data analysis, process, and result information generation so as to identify a first section corresponding to a trigger word based on a received audio signal, identify whether a third section corresponding to a user speech input is present in the audio signal received after the first section based on a noise characteristic identified from a second section of the audio signal received before the identified first section, and perform an operation corresponding to the user speech input based on the audio signal of the identified third section.

An AI system may refer, for example, to a computer system that has an intelligence level approximating a human, in which a machine learns and determines by itself and recognition rates are improved the more it is used.

The AI technology is based on elementary technology by utilizing machine learning (deep learning) technology and machine learning algorithms using an algorithm of autonomously classifying/learning features of input data to copy perception, determination and the like functions of a human brain.

The elementary technology may for example include at least one of linguistic comprehension technology for recognizing a language/text of a human, visual understanding technology for recognizing an object like a human sense of vision, deduction/prediction technology for identifying information and logically making deduction and prediction, knowledge representation technology for processing experience information of a human into knowledge data, and motion control technology for controlling a vehicle's automatic driving or a robot's motion.

The linguistic comprehension refers to technology of recognizing and applying/processing a human's language/character, and includes natural language processing, machine translation, conversation system, question and answer, speech recognition/synthesis, etc. The visual understanding refers to technology of recognizing and processing an object like a human sense of vision, and includes object recognition, object tracking, image search, people recognition, scene understanding, place understanding, image enhancement, etc. The deduction/prediction refers to technology of identifying information and logically making prediction, and includes knowledge/possibility-based deduction, optimized prediction, preference-based plan, recommendation, etc. The knowledge representation refers to technology of automating a human's experience information into knowledge data, and includes knowledge building (data creation/classification), knowledge management (data utilization), etc.

For example, the processor 180 may function as both a learner and a recognizer. The learner may implement a function of generating the learned neural network, and the recognizer may implement a function of recognizing (or deducing, predicting, estimating and identifying) the data based on the learned neural network.

The learner may generate or update the neural network. The learner may obtain learning data to generate the neural network. For example, the learner may obtain the learning data from the storage 140 or from the outside. The learning data may be data used for learning the neural network, and the data subjected to the foregoing operations may be used as the learning data to make the neural network learn.

Before making the neural network learn based on the learning data, the learner may perform a preprocessing operation with regard to the obtained learning data or select data to be used in learning among a plurality of pieces of the learning data. For example, the learner may process the learning data to have a preset format, apply filtering to the learning data, or process the learning data to be suitable for the learning by adding/removing noise to/from the learning data. The learner may use the preprocessed learning data for generating the neural network which is set to perform the operations.

The learned neural network may include a plurality of neural networks (or layers). The nodes of the plurality of neural networks have weight values, and performs neural network calculation through calculation between the calculation result of the previous layer and the plurality of weight values. The plurality of neural networks may be connected to one another so that an output value of a certain neural network can be used as an input value of another neural network. As an example of the neural network, there are a convolutional neural network (CNN), a deep neural network (DNN), a recurrent neural network (RNN), a restricted Boltzmann machine (RBM), a deep belief network (DBN), a bidirectional recurrent deep neural network (BRDNN) and deep Q-networks.

The recognizer may obtain target data to carry out the foregoing operations. The target data may be obtained from the storage 140 or from the outside. The target data may be data targeted to be recognized by the neural network. Before applying the target data to the learned neural network, the recognizer may perform a preprocessing operation with respect to the obtained target data, or select data to be used in recognition among a plurality of pieces of target data. For example, the recognizer may process the target data to have a preset format, apply filtering to the target data, or process the target data into data suitable for recognition by adding/removing noise. The recognizer may obtain an output value output from the neural network by applying the preprocessed target data to the neural network. Further, the recognizer may obtain a stochastic value or a reliability value together with the output value.

The learning and training data for the AI model may be created through an external server. However, it will be appreciated that, as necessary, the learning of the AI model is achieved in the electronic apparatus, and the learning data is also created in the electronic apparatus.

For example, the method of controlling the electronic apparatus 100 according to the disclosure may be provided as involved in a computer program product. The computer program product may include instructions of software to be executed by the processor 180 as described above. The computer program product may be traded as a commodity between a seller and a buyer. The computer program product may be distributed in the form of a machine-readable storage medium (for example, a compact disc read only memory (CD-ROM)) or may be directly or online distributed (for example, downloaded or uploaded) between two user apparatuses (for example, smartphones) through an application store (for example, Play Store™). In the case of the online distribution, at least a part of the computer program product may be transitorily stored or temporarily produced in a machine-readable storage medium such as a memory of a manufacturer server, an application-store server, or a relay server.

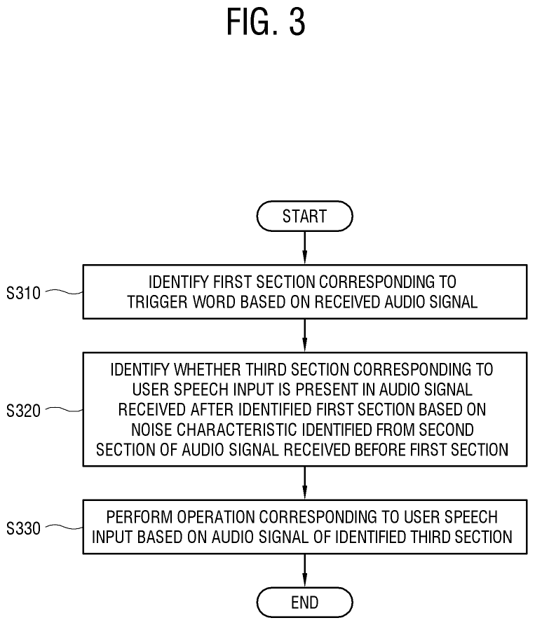

FIG. 3 is a flowchart illustrating example operations of an electronic apparatus according to various embodiments.

According to an embodiment of the disclosure, the processor 180 identifies a first section corresponding to a trigger word based on a received audio signal (S310).

The processor 180 identifies the first section corresponding to the trigger word in the received audio signal, based on information such as a waveform, a length, etc. of the audio signal corresponding to the trigger word. In this case, the processor 180 may use information previously stored in the storage 140, or obtain information through communication with a server or the like.

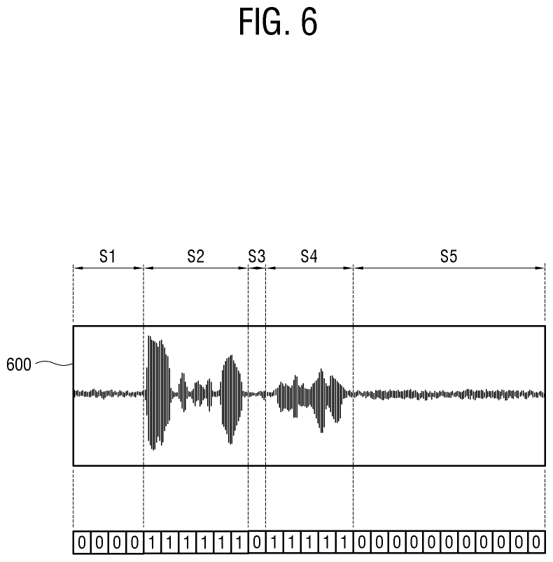

The processor 180 according to an embodiment of the disclosure may identify not only the trigger word in units of frames as shown in FIG. 6 to be described below based on the received audio signal but also identify the noise characteristic, the presence of the third section, etc. However, the analysis of the audio signal is not necessarily limited to the frame units.

According to an embodiment of the disclosure, the processor 180 identifies whether a third section corresponding to a user speech input is present in an audio signal received after the first section based on a noise characteristic identified based on a second section of an audio signal received before the identified first section (S320).

The processor 180 gets ready to identify the user speech input received subsequent to the end point of the first section corresponding to the trigger word. As described above, there is a need of identifying the noise characteristic of the audio signal in order to separate noise from the received audio signal. The noise characteristic refers to a characteristic for extracting an audio signal corresponding to noise from the received signal, and includes a signal-to-noise ratio (SNR) as compared with a speech characteristic of the first section. To separate the audio signal corresponding to the noise, the foregoing VAD, EPD or the like technology may be used.

In this case, the noise characteristic of the audio signal may be varied in accuracy or efficiency depending on which section of the received audio signal it is extracted from. For example, when an interval between a section including the trigger word and a section including the user speech input is short, the processor 180 may not have enough information to distinguish between the speech and the noise, and is decreased in efficiency and reliability of the speech recognition because it is difficult to extract the end point of the trigger word or the start point of the user speech input.

Therefore, the processor 180 according to an embodiment of the disclosure identifies the noise characteristic from the second section of the audio signal received before the first section identified as the section corresponding to the trigger word. As described above, the processor 180 may identify the noise characteristics in units of frames based on the received audio signal.

Further, the identification of the noise characteristic based on the second section is activated under the condition that the trigger word has already been identified in the first section and the speech-recognition function is triggered, and therefore there is no need of worrying about resource consumption because the identification is not always activated unlike the VAD or the EPD.

The second section refers to a section for helping to separate and identify the speech and the noise, and the processor 180 identifies the second section including a margin time preceding the start point of the first section.

A criterion of speech and a criterion of noise to identify the speech and the noise may be varied depending on surroundings. Because accuracy is lowered when absolute criteria are used to identify the speech and the noise in units of frames, it is important to set the criteria of the noise and the speech with respect to an audio signal received at present. For example, the processor 180 may set the noise section based on that the length of the first section corresponding to a previously defined trigger word does not exceed a specific time.

Likewise, the processor 180 may identify the presence of the third section in units of frame based on the received audio signal.

The processor 180 employs the noise characteristic identified in the second section to identify the user speech input received after the first section in units of frames, and thus easily identify valid speech in the third section even though an interval between the first section and the third section is short.

For example, a user's speech may be extracted by applying beamforming technology to the noise characteristic of the audio signal received in the second section. The beamforming technology refers to a method of creating a spatial filter by extracting an audio signal in a specific direction but removing audio components in the other directions. An audio signal identified as noise is extracted from the audio signal received in the second section, and the audio signal extracted from the audio signal received in the third section is filtered to allow only valid speech to pass a speech recognition system. Besides, any technology may be used without limitations as long as it can extract speech from the third section based on the audio signal corresponding to the noise extracted from the second section.

In addition, the processor 180 may identify a speech characteristic based on the first section, and perform an operation corresponding to the user speech input of the third section based on the identified speech characteristic. In this case, the reliability of the speech recognition is improved when the speech characteristic identified in the first section is used to identify the speech in the third section, because the user speech input will be spoken by the same user who have already spoken the trigger word unless in exceptional cases.

According to an embodiment of the disclosure, the processor 180 performs (or may cause or control a separate device to perform) an operation corresponding to the user speech input based on the audio signal of the identified third section (S330).

The processor 180 may obtain text data through speech-to-text (STT) processing of converting the audio signal of the identified third section into the text data.

The processor 180 may include a natural language processing engine. The natural language processing engine refers to an engine for natural language understanding (NLU), and the processor 180 may use the natural language processing engine to deduce not only a user's utterance but also real meaning of the user's utterance. The natural language processing engine may be, but not limited to, based on repetitive learning of a variety of data through AI technology, or based on rules. The processor 180 uses the natural language processing engine to identify a user's speech based on the obtained text data, thereby performing an operation corresponding to the identified speech.

The processor 180 may transmit the audio signal of the identified third section to an external server, which includes the engine, e.g., the STT processing engine, the natural language processing engine, or the like for the speech recognition through the interface 110, thereby performing the operation corresponding to the user speech input.

According to an embodiment of the disclosure, a present noise characteristic and a present speech characteristic based on a triggered point of a trigger word are used to efficiently and accurately analyze a user speech input while consuming the minimum and/or reduced system resources with regard to a speaking section and a noise section.

According to an embodiment of the disclosure, it is possible to clearly identify the speaking section and the noise section even under an environment with included noise, thereby guiding a user to normally input speech while checking his/her own speech input state. Further, operations are performed after the recognition of the trigger word, thereby having advantages of consuming the minimum and/or reduced system resources and exhibiting performance even under the noisy environment without depending on a specific threshold value.

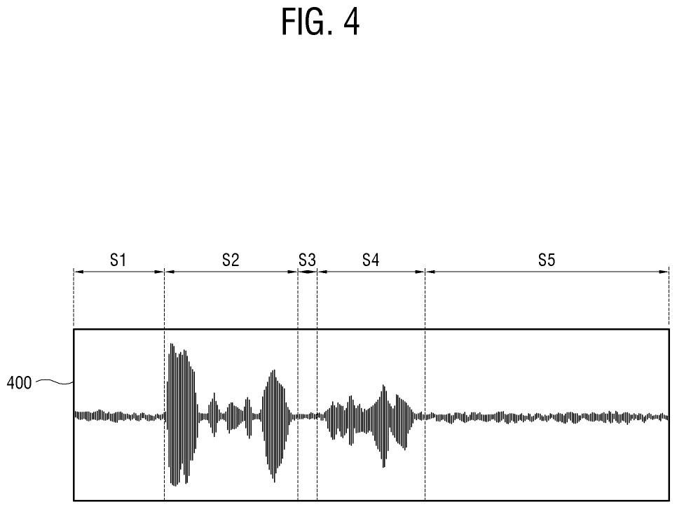

FIG. 4 is a diagram illustrating an example audio signal received in an electronic apparatus according to various embodiments.

An audio signal 400 shown in FIG. 4 includes five sections S1, S2, S3, S4 and S5. The following descriptions will be made by equivalently applying such five sections throughout FIGS. 4, 5, 6 and 7, and by equally using sections corresponding to the first, second and third sections described with reference to FIG. 3.

The section S1 refers to a section immediately before speaking the trigger word, which corresponds to the second section of FIG. 3. The section S2 refers to a section in which the trigger word is spoken, which corresponds to the first section of FIG. 3. The section S3 refers to a section between speaking of the trigger word and speaking of the user speech input. The section S4 refers to a section in which the user speech input is spoken, which corresponds to the third section. The section S5 refers to a section after the user speech input is spoken.

In light of the flowchart of the electronic apparatus shown in FIG. 3, descriptions will be made below in greater detail.

The processor 180 identifies a first section S2 corresponding to the trigger word based on the received audio signal 400.

The electronic apparatus 100 further includes the storage 140, so that the processor 180 can update some sections of the audio signal 400 and store the received audio signal 400 in the storage 140. As described above, the storage 140 includes the volatile memory, e.g., the buffer. If all the audio signals received in succession are stored, the capacity of the storage 140 is insufficient, and the speed of the speech recognition may be lowered. Therefore, the processor 180 may receive the audio signals in real time, and store the audio signals in the buffer in such a manner that some sections of the received audio signal 400 are updated.

For example, the processor 180 may store data, which is related to the lengths of time corresponding to the first section S2 and the second section S1 of the received audio signal 400, in the storage 140. The processor 180 may identify the first section S2 and the second section S1 based on the data stored in the storage 140.

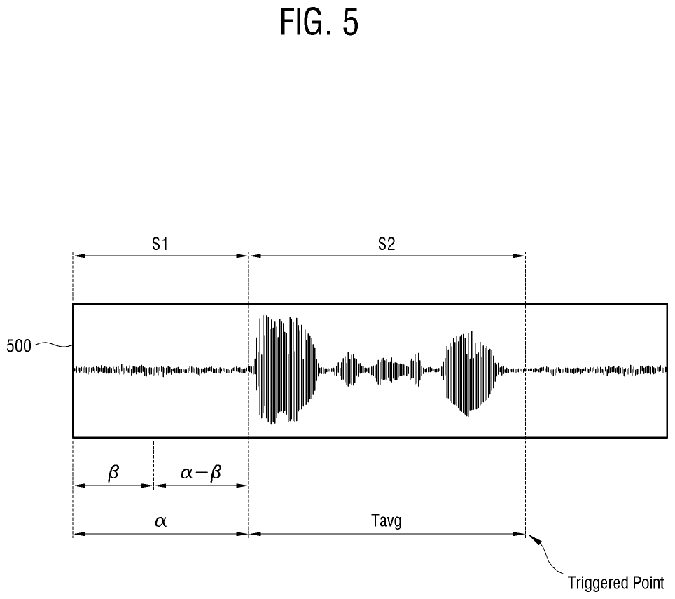

In this case, when a margin time is employed, the second section S1 includes a section corresponding to the margin time from the start point of the first section S2 and a section preceding the margin time. The margin time refers to a section given to precede the first section S2 because it is difficult to exactly identify a length of time corresponding to the first section S2. When the noise characteristic of the audio signal received in the second section S1 is identified, the processor 180 may identify the noise characteristic based on a section preceding a section corresponding to the margin time from a point expected as the start point of the first section S2. In this case, it is possible to reduce a probability of mixing with the audio signal corresponding to the trigger word of the first section S2 while the noise characteristic of the second section S1 is identified, thereby increasing the reliability. The margin time will be described in greater detail below with reference to FIG. 5.

For example, when the processor 180 identifies the first section S2 corresponding to the trigger word while receiving the audio signal, the processor 180 identifies the second section S1 including the margin time from the start point of the first section S2 in the data about the audio signal stored in the storage 140. Further, the processor 180 identifies the noise characteristic based on the identified second section S1 in the storage 140.

The processor 180 gets ready to identify the user speech in put received from after the end point of the first section S2 based on the noise characteristic identified in the second section S1. If the second section S1 is not employed in identifying the noise characteristic, the processor 180 does not have enough information to distinguish between the speech and the noise when the section S3 between the first section S2 including the trigger word and the third section S4 including the user speech input is short, and it is difficult to extract the end point of the first section S2 or the start point of the third section S4, thereby decreasing the efficiency and reliability of the speech recognition.

Further, the identification of the second section S1 and the identification of the noise characteristic using the first section S2 are activated under the condition that the trigger word has already been identified in the first section, and therefore there is no need of worrying about wasteful resource consumption as described above.

According to an embodiment of the disclosure, the processor 180 identifies whether the third section S4 corresponding to the user speech input is present in the audio signal received after the first section S2 based on the identified noise characteristic.

The processor 180 employs the noise characteristic identified in the second section S1, so that the user speech input received after the first section S2 can be identified in units of frames, thereby easily identifying the valid speech in the third section S4 even though an interval between the first section S2 and the third section S4 is short.

Therefore, the processor 180 can identify the end point of the first section S2 based on the noise characteristic identified in the second section S1, and identify whether the third section S4 is present in the audio signal received after the identified end point.

In addition, the processor 180 can identify the speech characteristic based on the first section S2, and perform an operation corresponding to the user speech input of the third section S4 based on the identified speech characteristic. In this case, the reliability of the speech recognition is further improved when the speech characteristic identified in the first section S2 is used to identify the speech in the third section S4, because the user speech input will be spoken by the same user who have already spoken the trigger word unless in exceptional cases.

According to an embodiment of the disclosure, the processor 180 performs (or may cause or control another device to perform) an operation corresponding to the user speech input based on the audio signal of the identified third section S4.

In this case, the processor 180 may identify the speech characteristic based on the third section S4. Further, the speech characteristic previously identified based on the first section S2 and the speech characteristic of the third section S4 are compared with each other to identify whether they are spoken by the same user, so that the operation corresponding to the user speech input can be performed based on the audio signal of the third section S4 only in case of the same user.

According to an embodiment of the disclosure, the operations are performed while updating the audio signal through the buffer during the operations, thereby increasing the processing speed of the speech recognition and using the resources efficiently. Further, the operations are performed based on matching between the audio signals corresponding to the trigger word and the user speech input match, thereby reducing an error in speech recognition or wasteful operations, and being efficient because the user speech input is more accurately recognized.

FIG. 5 is a diagram illustrating an example audio signal received in an electronic apparatus according to various embodiments. With this diagram, the first section S2 and the second section S1 will be described in greater detail.

The processor 180 may identify the length of time corresponding to the first section S2 based on a standard length Tavg of the first section S2 based on a reference audio signal.

The first section S2 refers to a section corresponding to the trigger word, and at least one trigger word for activating the speech-recognition function has already been set for each individual electronic apparatus. The standard length Tavg may be set based on the reference audio signal on the premise that length of time taken in speaking a given trigger word does not exceed a certain period of time even though the lengths of taken time are different according to users. The reference audio signal may be generated based on information about lengths, waveforms, etc. of the audio signals corresponding to the trigger word, which are collected from various users by the processor 180. However, without limitations, a previously generated reference audio signal may be received from a server, or the reference audio signal received from the server or the like may be stored in the storage 140. Further, the reference audio signal may be provided according to the trigger words as well as the users but also.

The processor 180 may obtain the information based on information about the standard length Tavg previously stored in the storage 140 or based on communication with the server or the like through the interface 110, and identify the standard length Tavg of the first section S2 based on the reference audio signal.

The processor 180 may identify a length α of the second section S1 based on the standard length Tavg. The processor 180 may buffer an audio signal 500, the length of which is the sum of the length Tavg of the following first section S2 and the length α of the previous second section S1 with respect to the triggered point of the trigger word, in the storage 140. Further, as described above with reference to FIG. 4, when the length α of the second section S1 includes a margin time α-β, the processor 180 may identify the noise characteristic based on an audio signal corresponding to a length of a preceding part β (<α). In this case, the processor 180 may identify a section (e.g., a section having the length of β) preceding the margin time α-β within the second section S1, from the start point of the first section S2. Thus, it is possible to more precisely distinguish between the first section S2 and the second section S1, thereby increasing accuracy of identifying the noise characteristic of the second section S1.

However, without limitations, energy of a frame preceding the first section S2 may be analyzed to store a frame higher than a certain value in the storage 140, and then the lengths α and β may be identified in real time. Further, the standard length Tavg varying depending on a user may be applied based on information about the user, such as the sex, language, use history, etc. of the user who speaks at preset. The processor 180 may obtain information about a user, based on login or the like for using the speech-recognition function, reception from the server or the like, the use history stored in the storage 140, etc.

The processor 180 may identify the standard length Tavg of the first section S2 based on the reference audio signal, and identify the end point of the first section S2, e.g., the triggered point of the trigger word based on the identified standard length Tavg.

For example, the processor 180 may store data, which is related to the lengths of time corresponding to the first section S2 and the second section S1 of the received audio signal, in the storage 140. The processor 180 may identify the first section S2 and the second section S1 based on the data stored in the storage 140.

According to an embodiment of the disclosure, the sections of the audio signal to be stored is identified with respect to the standard length Tavg, thereby clearly distinguishing the speech and the noise while consuming less resources.

Further, according to an embodiment of the disclosure, the margin time α-β is provided in the first section S2, and it is thus possible to lower a probability of mistaking the identification of the noise characteristic even when the first section S2 is not clearly distinguished from the second section S1, for example, there is a lot of noise, the noise is identified as a user's speech, and so on, thereby increasing the reliability of identifying the noise characteristic and further increasing the reliability of the speech recognition.

FIG. 6 is a diagram illustrating an example audio signal received in an electronic apparatus according to various embodiments. With this diagram, it is illustrated that sections of an audio signal 600 are identified in units of frames.

As described above with reference to FIGS. 3, 4 and 5, the processor 180 according to an embodiment of the disclosure may identify the noise characteristic of the second section S1, the presence of the third section S4, etc. as well as the first section S2 of the trigger word, in units of frames based on the received audio signal 600.

The audio signal 600 received according to the sections may as shown in FIG. 6 be identified by designating an audio signal corresponding to noise or silence as ‘0’ but designating an audio signal corresponding to valid speech as ‘1’. However, the method of designating the audio signal as ‘0’ or ‘1’ is merely an example, and the audio signal may be designated based on levels or other indexes.

According to an embodiment of the disclosure, the audio signal is analyzed in units of frames, thereby clearly distinguishing the start point and the end point of the speech.

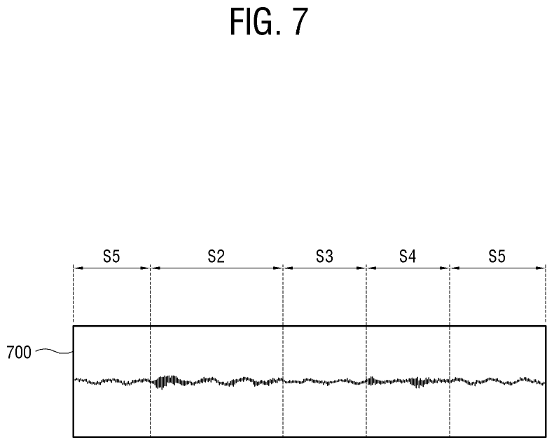

FIG. 7 is a diagram illustrating an example audio signal received in an electronic apparatus according to various embodiments.

FIG. 7 shows an audio signal 700 of which speech and noise are not clearly distinguished due to a low SNR based on mixture of the speech and the noise, etc.

If calculation is continuously performed in units of frames regardless of the recognition of the trigger word to more clearly distinguish between the speech and the noise, or the speech and the noise are identified after the recognition of the trigger word, identification performance may be remarkably degraded due to difference from an experimentally given threshold value, a problem of an ambiguous criterion, etc. in a particular case where the speech and the noise are not clearly identified like those of the audio signal shown in FIG. 7. Further, if the processing is carried out after the recognition of the trigger word, it is highly likely to fail in detecting noise in a case where the section S3 is short, and it is also highly likely to fail in the identification due to an ambiguous criterion.

As described above with reference to FIGS. 3, 4, 5 and 6, the triggered point of the trigger word, a speaking length of the trigger word, and buffering of the audio signal are used to specify the second section S1 and identify the noise characteristic, thereby reducing wasteful resource consumption and securing an accurate noise characteristic. Further, it is possible to additionally check the speech characteristic with regard to the speaking section of the trigger word, thereby clarifying difference in characteristic between the noise and the speech.

Further, the speech and the noise are identified in units of frames regardless of the length of the section S3 between the first section S2 and the third section S4, and thus general-purpose application is possible irrespective of users' speech types. In addition, the noise characteristic is not distinguished by a specific threshold value but identified at the moment when the trigger word is spoken, thereby securing the distinguishing performance that meets the corresponding conditions.

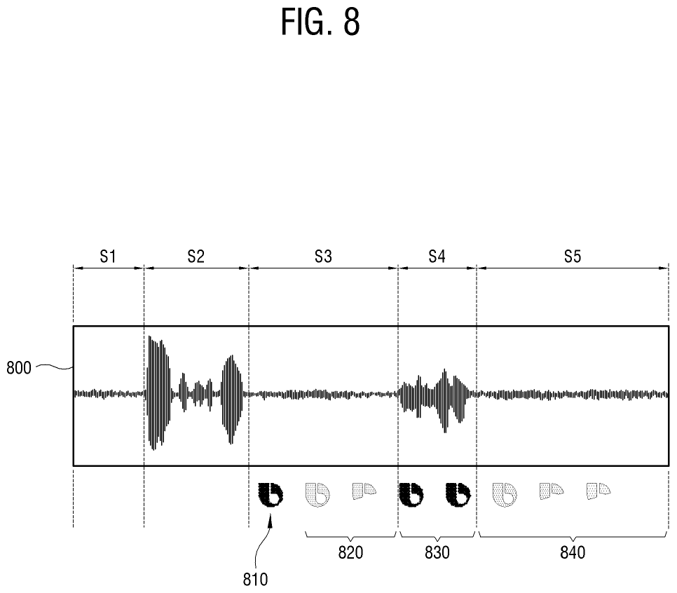

FIG. 8 is a diagram illustrating an example audio signal received in an electronic apparatus according to various embodiments.

The electronic apparatus 100 may further include the display, and the processor 180 may control the display to display graphic user interfaces 810, 820, 830 and 840 corresponding to changed states of an audio signal 800 received after the first section.

The processor 180 identifies the first section S2 corresponding to the trigger word in the received audio signal 800, and controls the display to display the GUI 810 showing that the speech-recognition function is triggered at the end point (trigger point) of the first section S2.

The processor 180 may identify whether the audio signal in each section is a user's speech or noise based on the changed state of the audio signal 800, and control the display to display the GUI 820, 830 or 840 changed from the GUI 810 based on the identified user's speech or noise.

As described above, the changed state of the audio signal 800 includes how long the speech or noise lasts based on the identified speech and noise characteristics.

The processor 180 may change the displayed GUI 810 into the GUI 820 in the noisy or silent section S3, and control the display to display the GUI 820. In this case, the processor 180 may control the display to display the GUI 820 being variously changed, for example, being gradually paled, being changed in color, being gradually decreased in size, being changed in shape with a disappearing part of the GUI 820, etc. This is to make a user intuitively know the state of the processor 180 that receives the speech recognition. Thus, through the GUI 820 displayed on the display, a user can easily realize that the speech-recognition function will be terminated soon if the user speech input is not spoken within a predetermined period of time.

Further, the processor 180 controls the display to display the GUI 810 based on the identification of the received audio signal corresponding to the trigger word, thereby allowing a user to realize that the speech-recognition function is activated in response to the trigger word. On the other hand, the processor 180 controls the display not to display the GUI 810 when the audio signal corresponding to the trigger word is not identified due to surrounding noise or the like, thereby allowing a user to realize that the electronic apparatus 100 does not receive the trigger word.

With this, a user can realize stepwise errors in the speech recognition processes about whether the electronic apparatus 100 recognizes the trigger word, whether the electronic apparatus 100 recognizes the trigger word but does not recognize the user speech input, etc.

When a user speaks a user speech input in the third section S4, the processor 180 receives an audio signal corresponding to the user speech input, and identifies change in the state of the received audio signal. Therefore, the processor 180 changes the GUI 830 displayed on the display into a form to be activated again, and controls the display to display the changed GUI 830.

After receiving the audio signal corresponding to the user speech input, the processor 180 changes the GUI 840 in the noisy or silent section S3 and controls the display to display the changed GUI 840. The GUI 840 may be changed in the same way as the GUI 820. Therefore, likewise, through the GUI 840 displayed on the display, a user can easily realize that the speech-recognition function will be terminated soon if the user speech input is not spoken within a predetermined period of time.

In addition, the processor 180 may change the GUI 810 into the GUI 820, 830 or 840 as time goes on as well as the changed state of the audio signal, thereby controlling the display to display that time for the speech-recognition function is running out.

As no speech is input for a predetermined period of time, the GUI gradually disappears so that a user can realize that the speech-recognition function is terminated.

The processor 180 may control the display to display the GUI 810, 820, 830 and 840 differently according to the kinds of electronic apparatuses 100. In other words, a GUI for a TV or the like big electronic apparatus is displayed differently from a GUI for a mobile device or the like small electronic apparatus. For example, in a case of the TV, the GUI may be not displayed so as not to obstruct watching or may be displayed at a position where watching is not obstructed. On the contrary, the GUI may be not easily seen in the big electronic apparatus and thus be largely displayed as compared with the GUI for the mobile device or the like small electronic apparatus because. Such screen display setting for the display may be set by a user for his/her convenience, or may be previously set and then launched.

According to an embodiment of the disclosure, the process of performing the speech-recognition function of the processor 180 is shown to a user interactively with the changed state of the audio signal and the change of the GUI, thereby allowing the user to intuitively realize the operations of the speech recognition.

According to an embodiment of the disclosure, the GUI is displayed on the screen so that a user can input speech while checking the state of his/her own speech input, thereby guiding the user to make normal speech input and improving user convenience.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents.

What is claimed is:

1. An electronic apparatus comprising:
a processor configured to:
identify a first section of a received audio signal corresponding to a trigger word based on the received audio signal,
based on a noise characteristic identified from a second section of the audio signal received before the first section, identify whether a third section is present in the audio signal, the third section being received after the identified first section and corresponding to a user command word, and
causing an operation corresponding to the user command word to be performed based on the identified third section of the audio signal.

2. The electronic apparatus of claim 1, further comprising: a storage,
wherein the processor is configured to:
store data related to lengths of time corresponding to the first section and the second section of the received audio signal in the storage; and
identify the first section and the second section based on the stored data.

3. The electronic apparatus of claim 2, wherein the processor is configured to identify a length of time corresponding to the first section based on a standard length of the first section based on a reference audio signal.

4. The electronic apparatus of claim 1, wherein the processor is configured to identify presence of the third section or the noise characteristic in units of frames based on the received audio signal.

5. The electronic apparatus of claim 1, wherein the processor is configured to:
identify an end point of the first section based on the identified noise characteristic, and
identify whether the third section is present in the audio signal received after the identified end point.

6. The electronic apparatus of claim 5, wherein the processor is configured to:
identify a standard length of the first section based on a reference audio signal, and
identify the end point of the first section based on the identified standard length.

7. The electronic apparatus of claim 1, wherein the processor is configured to:
identify a speech characteristic based on the first section, and
causing an operation corresponding to a user command word of the third section to be performed based on the identified speech characteristic.

8. A method of controlling an electronic apparatus, the method comprising:
identifying a first section of a received audio signal corresponding to a trigger word based on the received audio signal;
identifying whether a third section is present in the audio signal based on a noise characteristic identified from a second section of the audio signal received before the first section, the third section being received after the identified first section and corresponding to a user command word; and
causing an operation corresponding to the user command word to be performed based on the identified third section of the audio signal.

9. The method of claim 8, further comprising:
storing data related to lengths of time corresponding to the first section and the second section of the received audio signal; and
identifying the first section and the second section based on the stored data.

10. The method of claim 9, wherein the identifying the first section comprises identifying a length of time corresponding to the first section based on a standard length of the first section based on a reference audio signal.

11. The method of claim 8, further comprising:
identifying presence of the third section or the noise characteristic in units of frames based on the received audio signal.

12. The method of claim 8, further comprising:
identifying an end point of the first section based on the identified noise characteristic; and
identifying whether the third section is present in the audio signal received after the identified end point.

13. The method of claim 12, wherein the identifying the end point of the first section comprises:
identifying a standard length of the first section based on a reference audio signal; and
identifying the end point of the first section based on the identified standard length.

14. The method of claim 8, further comprising:
identifying a speech characteristic based on the first section, and
causing an operation corresponding to a user command word of the third section to be performed based on the identified speech characteristic.

15. A non-transitory computer-readable recording medium, having stored thereon a computer program comprising a code, which when executed by a processor or computer, causes an electronic apparatus to perform operations comprising:
identifying a first section of a received audio signal corresponding to a trigger word based on the received audio signal;
identifying whether a third section is present in the audio signal based on a noise characteristic identified from a second section of the audio signal received before the first section, the third section being received after the identified first section and corresponding to a user command word; and
causing an operation corresponding to the user command word to be performed based on the identified third section of the audio signal.
